(19) United States
(12) Patent Application Publication
(10) Pub. No.: US 2018/0087777 A1
(43) Pub. Date: Mar. 29, 2018

(54) COOKTOP APPLIANCE AND TEMPERATURE SWITCH

(71) Applicant: Haier US Appliance Solutions, Inc., Wilmington, DE (US)

(72) Inventor: Eugenio Gomez, Louisville, KY (US)

(21) Appl. No.: 15/275,519

(22) Filed: Sep. 26, 2016

(51) Int. Cl. F24C 7/06; H05B 3/22; F24C 7/04

(52) U.S. Cl. CPC F24C 7/062; H05B 2203/005; F24C 7/043; H05B 3/22

(57) ABSTRACT

A cooktop appliance is provided. The cooktop appliance may include a panel, an electric heating element, a drip pan, and a temperature switch. The electric heating element may be positioned at the panel. The drip pan may be attached to the panel and positioned below the electric heating element. The temperature switch may be disposed on a switch bracket such that the temperature switch engages the drip pan. The temperature switch may be operable to restrict a voltage to the electric heating element at a predetermined temperature.

### FIELD OF THE INVENTION

The present subject matter relates generally to cooktop appliances, and more particularly to electric cooktop appliances.

### BACKGROUND OF THE INVENTION

Cooking appliances, such as, e.g., cooktops or ranges (also known as hobs or stoves), generally include one or more heated portions for heating or cooking food items within a cooking utensil placed on the heated portion. The heated portions utilize one or more heating sources to output heat, which is transferred to the cooking utensil and thereby to any food item or items within the cooking utensil. Typically, a controller or other control mechanism, such as an electromechanical switch, regulates the heat output of the heating source selected by a user of the cooking appliance, e.g., by turning a knob or interacting with a touch-sensitive control panel. For example, the control mechanism may cycle the heating source between an activated or on state and a substantially deactivated or off state such that the average heat output of the heating source corresponds to the user-selected heat output level.

The control mechanism can utilize a temperature sensor to help control the heat output in order to regulate or otherwise limit the cooking utensil from reaching an undesired temperature level. The transfer of heat to the cooking utensil and/or food items may cause the food items or cooking utensil to overheat or otherwise cause unwanted and/or unsafe conditions on the cooktop. Although conventional cooking appliances may include a safety feature for estimating temperature at the cooking utensil, such systems are often unable to provide a suitable evaluation of the current conditions near the burner or at a cooking utensil disposed thereon. Moreover, conventional appliances may be unable to quickly evaluate the current or “live” conditions near the burner. Undesirable swings in temperature may occur at the heating source and/or cooking utensil before conventional appliances are able to detect that an excessive or deficient temperature has been reached.

Accordingly, a cooktop appliance having a system for accurately detecting temperature conditions near a heat source would be desirable. More particularly, it may be desirable for a cooktop appliance to have a system that addresses one or more of the conditions discussed above.

### BRIEF DESCRIPTION OF THE INVENTION

Aspects and advantages of the invention will be set forth in part in the following description, or may be obvious from the description, or may be learned through practice of the invention.

In one aspect of the present disclosure, a cooktop appliance is provided. The cooktop appliance may include a panel, an electric heating element, a drip pan, a switch bracket, and a temperature switch. The electric heating element may be positioned at the panel. The drip pan may be attached to the panel and positioned below the electric heating element. The switch bracket may be attached to the panel. The temperature switch may be disposed on the switch bracket such that the temperature switch engages the drip pan. The temperature switch may be operable to restrict a voltage to the electric heating element at a predetermined temperature.

In another aspect of the present disclosure, a cooktop appliance is provided. The cooktop appliance may include a panel, an electric heating element, a drip pan, and a temperature switch. The electric heating element may be positioned at the panel. The electric heating element may include a first terminal and a second terminal. The drip pan may be attached to the panel and positioned below the electric heating element. The temperature switch may be mounted in engagement with the drip pan. The temperature switch may be electrically connected in series with the second terminal. The temperature switch may be operable to restrict a voltage to the electric heating element at a predetermined temperature.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a cooktop appliance according to an exemplary embodiment of the present disclosure.

FIG. 2 provides a schematic view of a certain components for a cooktop appliance according to exemplary embodiments of the present disclosure, wherein a temperature switch is provided in a deactivated state.

FIG. 3 provides a schematic view of the exemplary components for a cooktop appliance of FIG. 2, wherein the temperature switch is provided in an activated state.

FIG. 4 provides a schematic view of a certain components for a cooktop appliance according to other exemplary embodiments of the present disclosure, wherein a temperature switch is provided in a deactivated state.

FIG. 5 provides a schematic view of the exemplary components for a cooktop appliance of FIG. 4 wherein the temperature switch is provided in an activated state.

FIG. 6 provides a side perspective view of a heating assembly in a cooktop appliance according to exemplary embodiments of the present disclosure.

FIG. 7 provides a bottom perspective view of the exemplary heating assembly in a cooktop appliance of FIG. 6.

FIG. 8 provides a side perspective view of the exemplary heating assembly in a cooktop appliance of FIG. 6, wherein the drip pan has been removed from a panel.

FIG. 9 provides a side perspective view of the exemplary heating assembly in a cooktop appliance of FIG. 6, wherein the drip pan has been attached to the panel.

FIG. 10 provides a side perspective view of a heating assembly in a cooktop appliance according to other exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure provides a cooktop appliance that includes at least one heating assembly. The heating assembly may have one or more electric heating elements and drip pan that is positioned below the electric heating element(s). A temperature switch may touch the drip pan to detect the heat transmitted from the electric heating element(s). When the temperature switch detects a certain temperature, it may restrict or cut off a voltage to one or more of the electric heating elements. If and/or when the temperature falls by a sufficient amount, the temperature switch may permit or direct the voltage to the electric heating element(s).

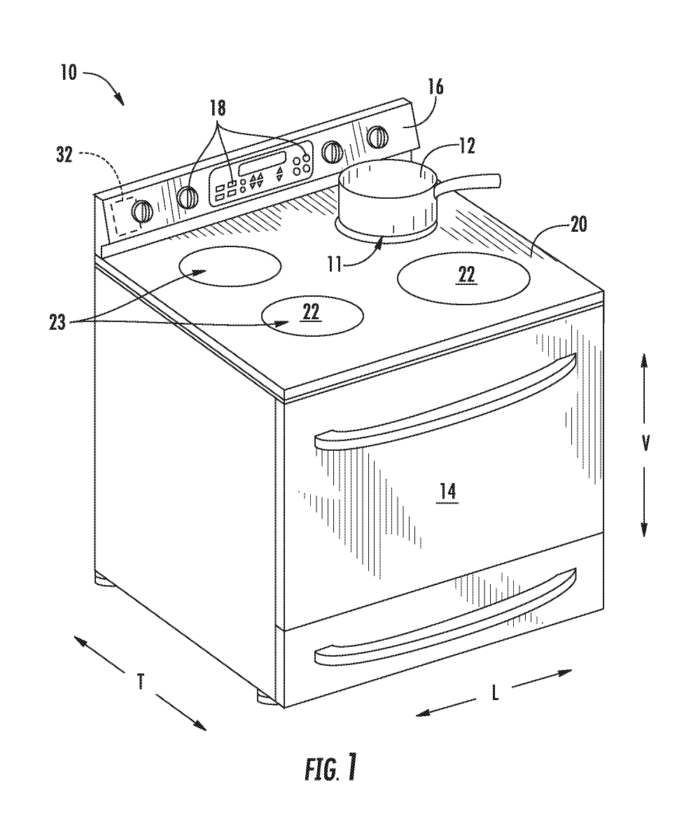

Turning now to the figures, FIG. 1 provides a perspective view of an exemplary cooktop appliance 10. Generally, cooktop appliance 10 defines a vertical direction V, a lateral direction L, and a transverse direction T. Each of the vertical direction V, lateral direction L, and transverse direction T may be mutually orthogonal to each other. As illustrated in FIG. 1, cooktop appliance 10 may be a range appliance that includes a horizontal cooking surface, such as a panel 20, disposed on and/or vertically above an oven cabinet. However, cooktop appliance 10 is provided by way of example only and is not intended to limit the present subject matter to any particular appliance or cooktop arrangement. Thus, the present subject matter may be used with other cooktop appliance configurations, e.g., cooktop appliances without an oven. Further, the present subject matter may be used in any other suitable appliance.

Panel 20 of cooktop appliance 10 includes one or more heating assemblies 22 having at least one heat zone 23. Panel 20 may be constructed of any suitable material, e.g., a ceramic, enameled steel, or stainless steel. As shown in FIG. 1, a cooking utensil 12, such as a pot, kettle, pan, skillet, or the like, may be placed or positioned on a heating assembly 22 to cook or heat food items placed within the cooking utensil 12. In some embodiments, cooktop appliance 10 includes a door 14 that permits access to a cooking chamber (not shown) of the oven cabinet of appliance 10, the cooking chamber for cooking or baking of food or other items placed therein.

Exemplary embodiments include a user interface 16 having one or more control inputs 18 permits a user to make selections for cooking of food items using heating assemblies 22 and/or the cooking chamber. As an example, a user may manipulate one or more control inputs 18 to select, e.g., a power or heat output setting for each heating assembly 22. The selected heat output setting of heating assembly 22 affects the heat transferred to cooking utensil 12 positioned on heating assembly 22. Although shown on a backsplash or back panel of cooktop appliance 10, user interface 16 may be positioned in any suitable location, e.g., along a front edge of the appliance 10. Control inputs 18 may include one or more buttons, knobs, or touch screens, as well as combinations thereof.

Some embodiments further include a controller 32 operably connected, e.g., electrically coupled, to user interface 16 and/or control inputs 18. Generally, operation of cooking appliance 10, including heating assemblies 22, may be controlled by controller 32. In some embodiments, controller 32 is a processing device and may include a microprocessor or other device that is in operable communication with components of appliance 10, such as heating assembly 22. Controller 32 may include a memory and microprocessor, such as a general or special purpose microprocessor operable to execute programming instructions or micro-control code associated with a selected heating level, operation, or cooking cycle. The memory may represent random access memory such as DRAM, and/or read only memory such as ROM or FLASH. In one embodiment, the processor executes programming instructions stored in memory. The memory may be a separate component from the processor or may be included onboard within the processor. Alternatively, controller 32 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Control inputs 18 and other components of cooking appliance 10 may be in communication with (e.g., electrically coupled to) controller 32 via one or more signal lines or shared communication busses. Heating assembly 22 may be operably connected to controller, e.g., at one or more respective terminal pairs.

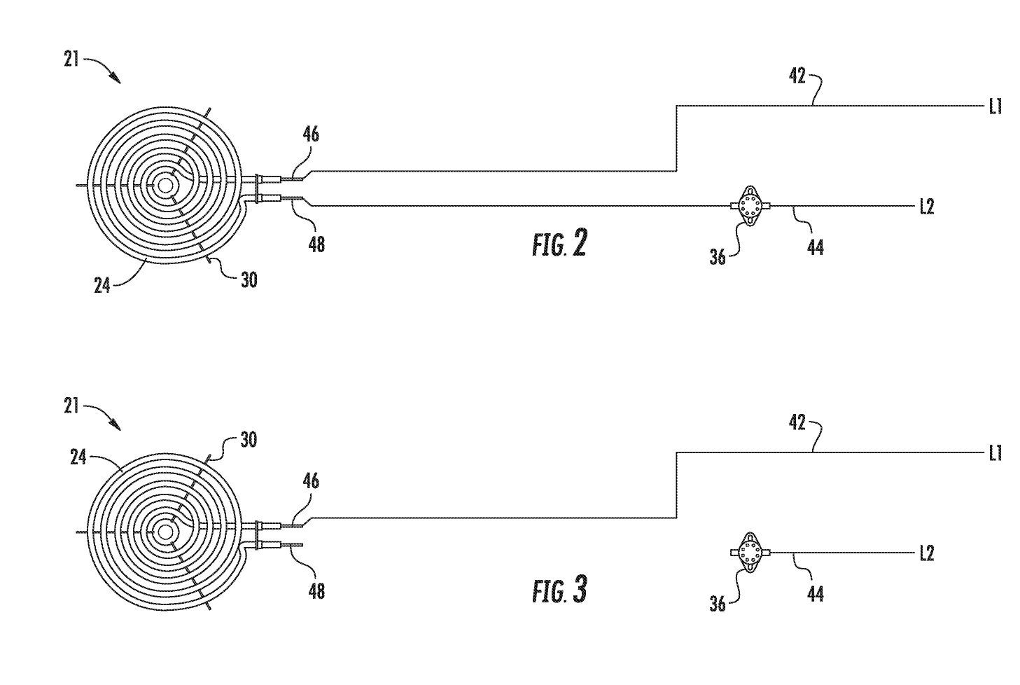

Operation of heating assembly 22 may be regulated such that the temperature or heat output of heating assembly 22 corresponds to a temperate or heat output selected by a user of cooktop appliance 10 For example, one or more electric heating elements 21 (FIGS. 3 through 6) may be cycled between an activated state and a deactivated state, i.e., between on and off, such that the average temperature or heat output over each cycle corresponds to or approximates the selected temperature or heat output. That is, a duty cycle of heating element 21 may be controlled such that, based on the user's selection, heating element 21 is activated or turned on for a fraction or portion of the duty cycle and deactivates or turns off heating element 21 for the remainder of the duty cycle. A user of cooktop appliance 10 may, e.g., manipulate a control 18 associated with a heating assembly 22 to select a desired heat output or temperature for heating element 21 of the associated heating assembly 22. The selection by the user indicates what fraction or portion of the duty cycle heating element 21 should be activated or on, e.g., if the user selects the midpoint heat output or temperature, the duty cycle of heating element 21 may be controlled such that heating element 21 is on for half of the duty cycle and off for half of the duty cycle.

As illustrated in FIGS. 2 and 3, some heating assembly 22 embodiments include an electric heating element 21 defining a heat zone 23 (FIG. 1). For instance, electric heating element 21 may be a single spiral shaped resistive coil for providing heat to a cooking utensil 12 (FIG. 1) positioned thereon. In some such embodiments, heating assembly 22 (FIG. 1) utilizes exposed, electrically-heated, planar coils that are helically-wound about a center point. Coils act as a heat source, i.e., as electric heating element 21, for heating cooking utensils 12 placed directly on heating assembly 22.

A first terminal 46 and a second terminal 48 may be provided for heating element 21. An electrical current may be transmitted to first resistive coil 24 at the terminals 46, 48. When a voltage differential is applied across first and second terminals 46, 48 of first resistive coil 24, a temperature of electric heating element 21 increases. First resistive coil 24 may be a CALROD® coil in certain exemplary embodiments.

A temperature switch 36 is generally provided as a safety mechanism separate from the controller 32. In some embodiments, temperature switch 36 is positioned adjacent electric heating element 21, as will be described in detail below. Generally, temperature switch 36 may be positioned such that a temperature of temperature switch 36 corresponds to a temperature of heating assembly 22 or cooking utensil 12 (FIG. 1) above heating assembly 22. Thus, temperature switch 36 may be configured for detecting the temperature of heating assembly 22 or cooking utensil 12 above electric heating element 21.

Temperature switch 36 may generally be operable to restrict a voltage to electric heating element 21 at a predetermined temperature. Specifically, temperature switch 36 may configured for actuating from a first, e.g., deactivated, state (FIG. 2) to a second, e.g., activated, state (FIG. 3), based on the detected temperature. For instance, certain embodiments of temperature switch 36 are provided as a bimetallic switch. Bimetallic temperature switch 36 actuates or adjusts from the first state to the second state when the temperature of bimetallic switch 36 exceeds a threshold temperature. Thus, the materials of bimetallic switch 36 may be selected to such that bimetallic temperature switch 36 triggers or trips at the threshold temperature. The threshold temperature may be any suitable temperature. For example, the threshold temperature may be about three hundred and twenty-five degrees Celsius. As another example, the threshold temperature may be between about ninety degrees Celsius and about four hundred degrees Celsius. As used herein, the term “about” corresponds to within twenty-five degrees of a stated temperature when used in the context of temperature. The threshold temperature may be may be selected such that the threshold temperature accounts for a position of bimetallic temperature switch 36 relative to heating assembly 22 and/or cooking utensil 12 (FIG. 1) above electric heating element 21.

A first electrical conduit 42 is coupled to first terminal 46 of electric heating element 21. First electrical conduit 42 is configured for operating at a first voltage, L1, with respect to ground. Thus, first electrical conduit 42 may be coupled or connected to a first voltage source operating at the first voltage L1 with respect to ground. Cooktop appliance 10 also includes a second electrical conduit 44 configured for operating at a second voltage, L2, with respect to ground. Thus, second electrical conduit 44 may be coupled or connected to a second voltage source operating at the second voltage L2 with respect to ground. The first and second electrical conduits 42, 44 may be any suitable electrical conduits, such as wires, cables, etc.

The first voltage L1 and the second voltage L2 have opposite polarities. In addition, a magnitude of the first voltage L1 with respect to ground may be about equal to a magnitude the second voltage L2 with respect to ground. As used herein, the term “about” corresponds to within ten volts of a stated voltage when used in the context of voltage. As an example, the magnitude of the first and second voltages L1, L2 may be about one hundred and twenty volts with respect to ground. Thus, e.g., first electrical conduit 42 may be coupled to one phase of a two-hundred and forty volt household electrical supply, and second electrical conduit 44 may be coupled to the second phase of the two-hundred and forty volt household electrical supply.

Temperature switch 36 may be connected to second conduit 44 in series between second terminal 48 and second voltage L2. As described above, temperature switch 36 may selectively adjust between a first and second state. Accordingly, temperature switch 36 may selectively couple or connect second terminal 48 to second electrical conduit 44. By selectively coupling or connecting the second terminal 48 of electric heating element 21 to second electrical conduit 44, a power output of electric heating element 21 may be regulated with temperature switch 36.

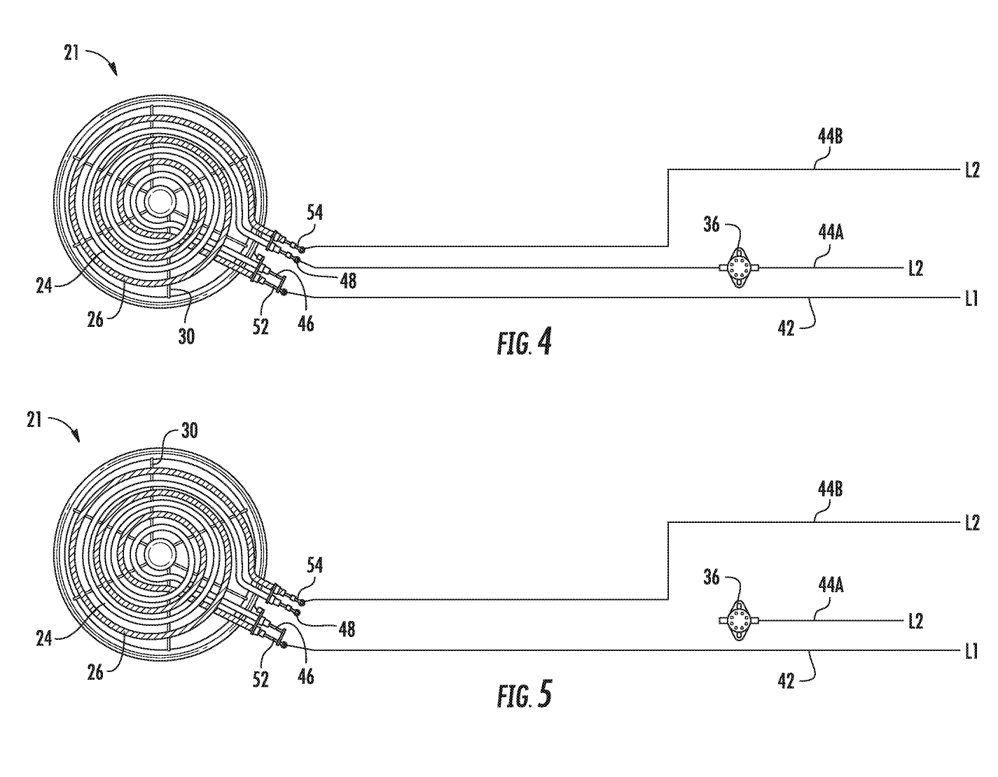

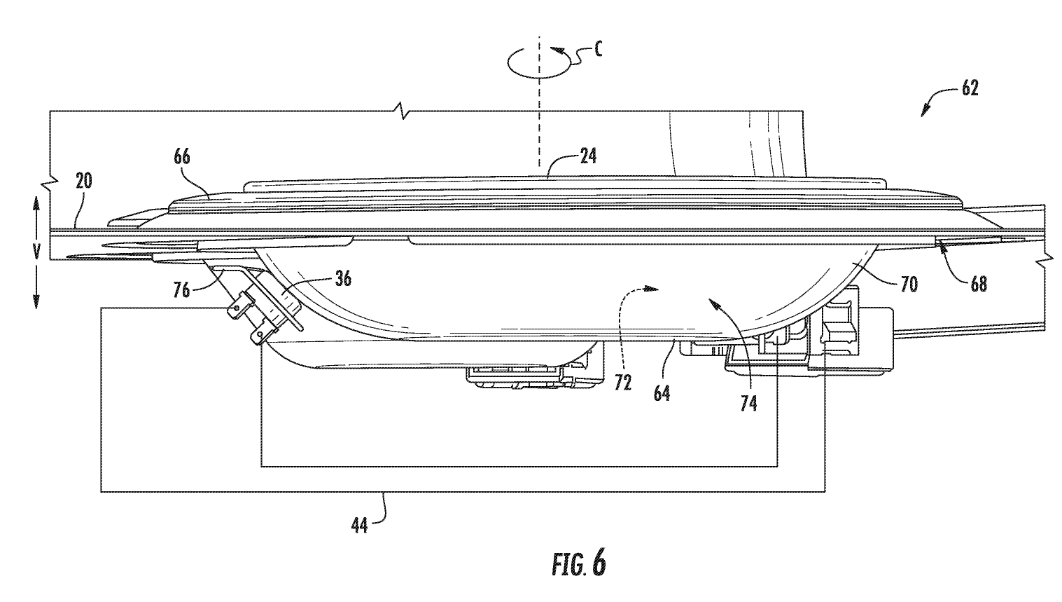

As illustrated in FIGS. 4 and 5, optional heating assembly 22 embodiments include multiple resistive coils, e.g., a first resistive coil 24 and a second resistive coil 26, defining a heat zone 23 (FIG. 1) and electric heating element 21. Both resistive coils, 26 may be formed about the same center point. For instance, segments of first resistive coil 24 may alternate with the segments of second resistive coil 26 such that first and second electric coils 24, 26 are intertwined about the center point.

A first terminal 46 and a second terminal 48 may be provided for first resistive coil 24. A third terminal 52 and a fourth terminal 54 may be provided for second resistive coil 26. An electrical current may be transmitted to each resistive coil 24, 26 at the terminals 46, 48, 52, 54. When a voltage differential is applied across first and second terminals 46, 48 of electrical first coil 24, a temperature of electric heating element 21 increases. Additionally or alternatively, when a voltage differential is applied across third and fourth terminals 52, 54, a temperature of electric heating element 21 increases. First resistive coil 24 and/or second resistive coil 26 may be a CALROD® coil in certain exemplary embodiments.

As noted above, temperature switch 36 may be positioned such that a temperature of temperature switch 36 corresponds to a temperature of heating assembly 22 or cooking utensil 12 (FIG. 1). Thus, temperature switch 36 may be configured for detecting the temperature of heating assembly 22 or cooking utensil 12 above electric heating element 21.

Temperature switch 36 may generally be operable to restrict a voltage to first resistive coil 24 and/or second resistive coil 26 at a predetermined temperature. Specifically, temperature switch 36 may configured for actuating from a first, e.g., deactivated, state (FIG. 4) to a second, e.g., activated, state (FIG. 5), based on the detected temperature. For instance, certain embodiments of temperature switch 36 are provided as a bimetallic switch. Bimetallic temperature switch 36 actuates or adjusts from the first state to the second state when the temperature of bimetallic switch 36 exceeds a threshold temperature. Thus, the materials of bimetallic switch 36 may be selected to such that bimetallic temperature switch 36 triggers or trips at the threshold temperature. The threshold temperature may be any suitable temperature. For example, the threshold temperature may be about three hundred and twenty-five degrees Celsius. As another example, the threshold temperature may be between about ninety degrees Celsius and about four hundred degrees Celsius. As used herein, the term “about” corresponds to within twenty-five degrees of a stated temperature when used in the context of temperature. The threshold temperature may be may be selected such that the threshold temperature accounts for a position of bimetallic temperature switch 36 relative to heating assembly 22 (FIG. 1) and/or cooking utensil 12 (FIG. 1) above electric heating element 21.

A first electrical conduit 42 is coupled to first terminal 46 of first resistive coil 24. In some embodiments, first electrical conduit 42 may be further coupled to third terminal 52 of second resistive coil 26, e.g., via a common conductive coupler connecting first terminal 48 and third terminal 52. Optionally, first resistive coil 24 and second resistive coil 26 may be coupled in parallel, as illustrated. First electrical conduit 42 is configured for operating at a first voltage, L1, with respect to ground. Thus, first electrical conduit 42 may be coupled or connected to a first voltage source operating at the first voltage L1 with respect to ground. A pair of second electrical conduits, e.g., a primary second conduit 44A and a matched second conduit 44B, each configured for operating at a second voltage, L2, with respect to ground. As shown, each second electrical conduit 44A, 44B is provided in parallel. Thus, each second electrical conduit 44A, 44B may be coupled or connected to a second voltage source operating at the second voltage L2 with respect to ground. The first and second electrical conduits 42, 44A, 44B may be any suitable electrical conduits, such as wires, cables, etc.

The first voltage L1 and the second voltage L2 have opposite polarities. In addition, a magnitude of the first voltage L1 with respect to ground may be about equal to a magnitude the second voltage L2 with respect to ground. As an example, the magnitude of the first and second voltages L1, L2 may be about one hundred and twenty volts with respect to ground. Thus, e.g., first electrical conduit 42 may be coupled to one phase of a two-hundred and forty volt household electrical supply, and each of second electrical conduits 44A, 44B may be coupled to the second phase of the two-hundred and forty volt household electrical supply.

Temperature switch 36 may be connected to at least one of second conduits 44A, 44B (e.g., primary second conduit 44A) in series between second terminal 48 and second voltage L2. As described above, temperature switch 36 may selectively adjust between a first and second state. Accordingly, temperature switch 36 may selectively couple or connect second terminal 48 to the one of second electrical conduits 44A. As shown, temperature switch 36 is electrically connected in series with first resistive coil 24. By selectively coupling or connecting the second terminal 48 of electric heating element 21 to second electrical conduit 44A, a power output of electric heating element 21 may be regulated with temperature switch 36. Temperature switch 36 may be electrically isolated from second resistive coil 26. For instance, as provided in the exemplary embodiments of FIGS. 4 and 5, temperature switch 36 may be parallel to the second conduit 44B that is connected in series with fourth terminal 54. The second resistive coil 26 may thus operate independent of temperature switch 36.

As illustrated in the exemplary embodiments of FIGS. 2 through 5, each electric heating element(s) 21 may be supported on one or more support elements 30, which also help support cooking utensil 12 (FIG. 1) when the cooking utensil 12 is placed on panel 30. Further, although illustrated as forming a spiral shape by winding in coils around a center point, resistive coil(s) 24 may have a different number of turns, other shapes, or other configurations as well. Heating assemblies 22 may have any suitable shape, size, and number of defined heating zones 23. Optionally, each heating assembly 22 of cooking appliance 10 (FIG. 1) may be heated by the same type of heating source, or cooking appliance 10 may include a combination of different types of heating sources. Cooking appliance 10 may include a combination of heating assemblies 22 of different shapes and sizes.

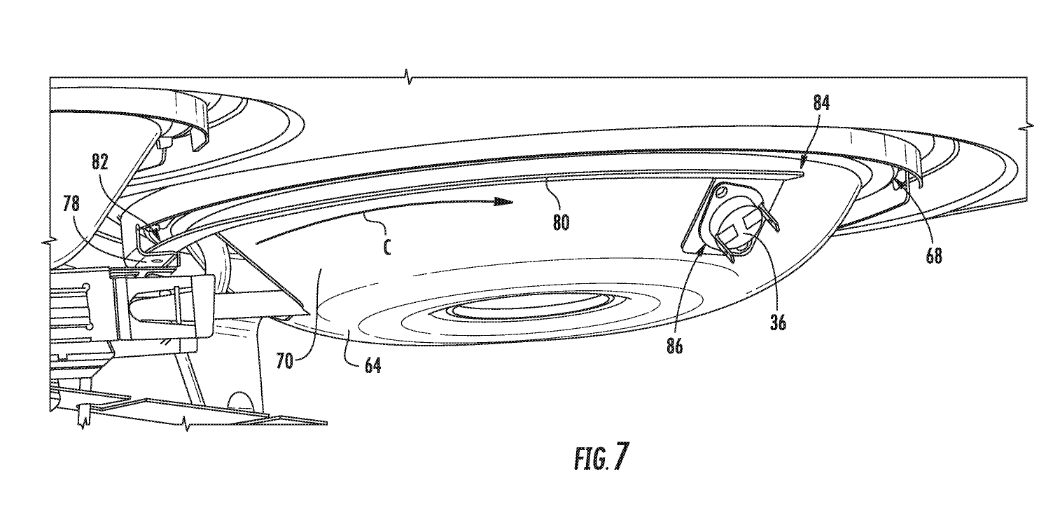

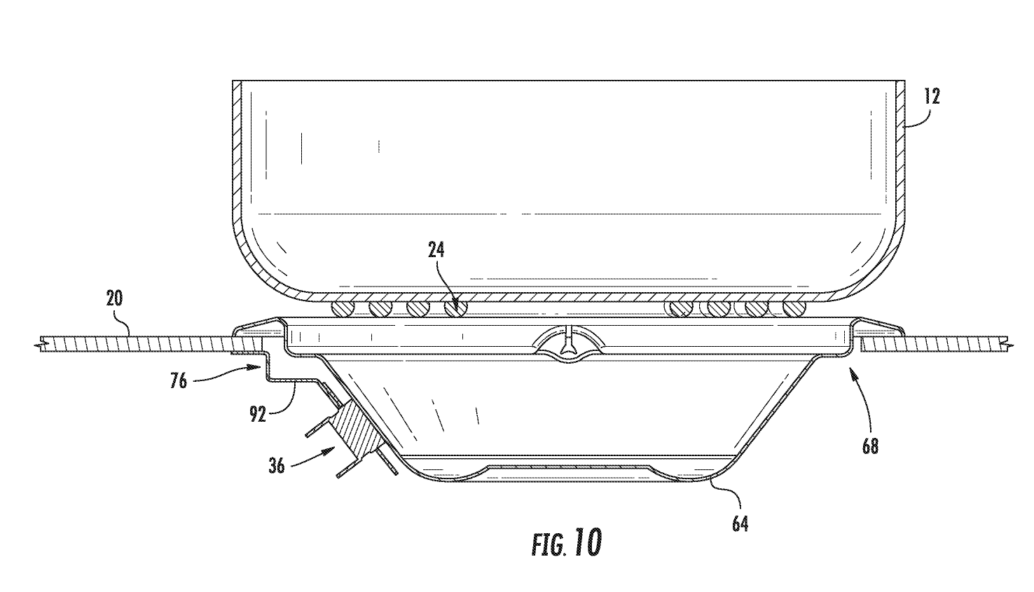

Turning now to FIGS. 6 through 9, an exemplary heating assembly 62 is illustrated. It is understood that heating assembly 62 may generally correspond to the heating assembly 22 of cooktop appliance 10 (FIG. 1). As shown, some embodiments of heating assembly 62 may include an electric heating element 21 positioned at panel 20. For instance, at least a portion of electric heating element 21 may be positioned above hole 68 defined through panel 20. A drip pan 64 may be attached, e.g., removably attached, to panel 20 below electric heating element 21. In some embodiments, drip pan 64 includes a support lip 66 extending along a circumferential direction C to rest on a top surface of panel 20, e.g., about hole 68. When mounted, a concave sidewall 70 may extend below panel 20. For example, a portion of concave sidewall 70 may extend through hole 68 from support lip 66. Concave sidewall 70 may include an inner surface 72 facing the hole 68 and/or electric heating element 21. An outer surface 74 of concave sidewall 70 may be positioned opposite inner surface 72 to face away from hole 68 and/or electric heating element 21. A pan aperture may be defined at a bottom portion of concave sidewall 70 to extend therethrough from inner surface 72 to outer surface 74.

In some embodiments, a switch bracket 76 is provided to hold temperature switch 36. For instance, a bracket tab 78 may extend from top panel 20, e.g., downward along the vertical direction V. Switch bracket 76 may be mounted to bracket tab 78 at the first end 82, e.g., via one or more mechanical fasteners. Alternatively, switch bracket 76 may be mounted directly to a burner box (not pictured), or another suitable support member disposed below drip pan 64. In certain embodiments, such as those pictured in FIGS. 6 through 9, temperature switch 36 is disposed on switch bracket 76 such that temperature switch 36 engages the drip pan 64. For instance, switch bracket 76 may include a resilient arm 80 that extends between a first end 82 and a second end 84. In a mounted configuration, switch bracket 76 may extend generally along the circumferential direction C, Switch bracket 76 may be attached to panel 20 at a first end 82. Temperature switch 36 may disposed on the second end 84 of resilient arm 80. In some such embodiments, resilient arm 80 defines a channel 86 to receive temperature switch 36 at the second end 84.

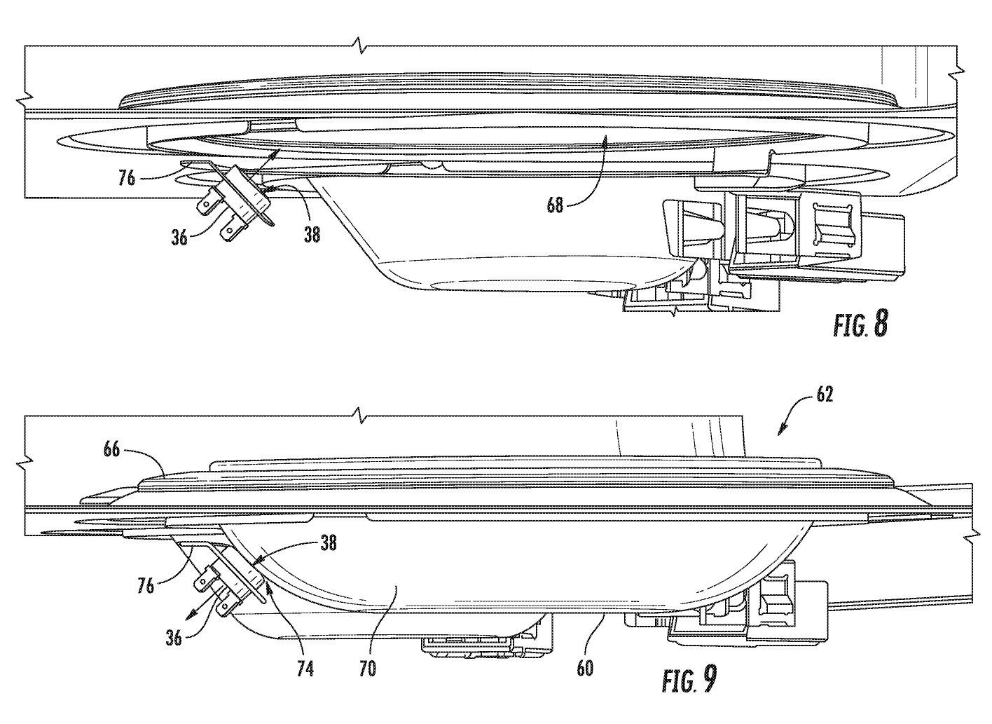

Resilient arm 80 may generally bias towards drip pan 64. In the exemplary embodiments of FIGS. 6 through 9, resilient arm 80 is formed as a cantilevered flat spring. In a non-engaged state, e.g., when drip pan 64 has been removed from hole 68 (FIG. 8), resilient arm 80 may hold temperature switch 36 beneath the vertical footprint of hole 68. In an engaged state, e.g., when drip pan 64 has been attached to panel 20, drip pan 64 may engage temperature switch 36 and deflect resilient arm 80. For instance, drip pan 64 may deflect resilient arm 80 away from the position of resilient arm 80 in the non-engaged state, e.g., away from concave sidewall 70.

Although a resilient arm 80 is illustrated in FIGS. 6 through 9, alternative embodiments of switch bracket 76, such as the embodiment illustrated in FIG. 10, may include a rigid tab 92 attached to the panel 20. Temperature switch 36 may be mounted to the rigid tab 92 at a fixed position relative to the panel 20. In other words, temperature switch 36 may remain stationary relative to the rigid tab 92 and panel 20, regardless of whether temperature switch 36 engages drip pan 64. In alternative embodiments, switch bracket 76, including rigid tab may be mounted directly to a burner box (not pictured), or another suitable support member disposed below drip pan 64.

When assembled in an engaged state, temperature switch 36 may contact drip pan 64. For instance, temperature switch 36 may contact outer surface 74 of drip pan 64. A flat face-plate 38 may directly contact a portion of outer surface 74 of concave sidewall 70. Advantageously, temperature switch 36 may be able to quickly detect and respond to variations in temperature at drip pan 64 and electric heating element 21. Moreover, flat face-plate 38 may allow a point of constant contact between concave sidewall 70 and temperature switch 36, regardless of movement or tolerances of drip pan 64.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooktop appliance comprising:
a panel;
an electric heating element positioned at the panel;
a drip pan attached to the panel and positioned below the electric heating element;
a switch bracket attached to the panel; and
a temperature switch disposed on the switch bracket such that the temperature switch engages the drip pan, the temperature switch operable to restrict a voltage to the electric heating element at a predetermined temperature.

2. The cooktop appliance of claim 1, wherein the electric heating element comprises a first resistive coil.

3. The cooktop appliance of claim 2, wherein the temperature switch is electrically connected in series with the first resistive coil.

4. The cooktop appliance of claim 2, wherein the electric heating element further comprises a second resistive coil.

5. The cooktop appliance of claim 4, wherein the temperature switch is electrically connected in series with the first resistive coil and electrically isolated from the second resistive coil.

6. The cooktop appliance of claim 1, wherein the switch bracket includes a resilient arm biased towards the drip pan.

7. The cooktop appliance of claim 6, wherein the resilient arm extends along a circumferential defined about the drip pan.

8. The cooktop appliance of claim 1, wherein the switch bracket includes a rigid tab attached to the panel, and wherein the temperature switch is mounted to the rigid tab at a fixed position relative to the panel.

9. The cooktop appliance of claim 1, wherein the drip pan includes a concave sidewall, and wherein the temperature switch is mounted in contact with the drip pan.

10. The cooktop appliance of claim 9, wherein the temperature switch includes a flat face-plate in contact with the concave sidewall.

11. A cooktop appliance comprising:
a panel;
an electric heating element positioned at the panel, the electric heating element including a first terminal and a second terminal;
a drip pan attached to the panel and positioned below the electric heating element; and
a temperature switch mounted in engagement with the drip pan, the temperature switch being electrically connected in series with the second terminal, the temperature switch being operable to restrict a voltage to the electric heating element at a predetermined temperature.

12. The cooktop appliance of claim 11, wherein the electric heating element comprises a first resistive coil comprising the first terminal and the second terminal.

13. The cooktop appliance of claim 12, wherein the electric heating element comprises a second resistive coil comprising a third terminal and a fourth terminal.

14. The cooktop appliance of claim 13, further comprising:
a first electrical conduit connected in series with the first terminal and the third terminal,
a second electrical conduit connected in series with the second terminal and the temperature switch, and
a third electrical conduit connected in series with the fourth terminal.

15. The cooktop appliance of claim 11, further comprising a switch bracket attaching the temperature switch to the panel.

16. The cooktop appliance of claim 11, wherein the switch bracket includes a resilient arm biased towards the drip pan.

17. The cooktop appliance of claim 16, wherein the resilient arm extends along a circumferential defined about the drip pan.

18. The cooktop appliance of claim 11, wherein the switch bracket includes a rigid tab attached to the panel, and wherein the temperature switch is mounted to the rigid tab at a fixed position relative to the panel.

19. The cooktop appliance of claim 11, wherein the drip pan includes a concave sidewall, and wherein the temperature switch is mounted in contact with the drip pan.

20. The cooktop appliance of claim 19, wherein the temperature switch includes a flat face-plate in contact with the concave sidewall.
